(19) United States
(12) Patent Application Publication
(10) Pub. No.: US 2011/0138447 A1
(43) Pub. Date: Jun. 9, 2011

(54) Method, System and Device for Obtaining a Trust Type of a Non-3GPP Access System

(75) Inventor: Hui Xu, Beijing (CN)

(73) Assignee: DATANG MOBILE COMMUNICATIONS EQUIPMENT CO., LTD., Beijing (CN)

(21) Appl. No.: 12/991,423

(22) PCT Filed: May 5, 2009
(86) PCT No.: PCT/CN2009/000491

§ 371 Date: Feb. 2, 2011

(30) Foreign Application Priority Data
May 5, 2008 (CN) 200810105783.4

(51) Int. Cl. G06F 15/16

(52) U.S. Cl. 726/4

(57) ABSTRACT

The invention provides a method for obtaining a trust type of a non-3GPP access system comprising the following steps: a user equipment UE establishing a underlying link with a non-3GPP access system selected by the UE; the UE initiating an access authentication request and sending the identification information of the UE and the information of the non-3GPP access system to an Authentication, Authorization, Accounting server through the non-3GPP access system; the UE receiving a returned access authentication response and the trust type of the non-3GPP access system, and the trust type of the non-3GPP access system being determined by the AAA server based on the identification information of the UE, the information of the non-3GPP access system and the operator's strategy. The invention can realize that the trust type of the non-3GPP access system is determined and is informed to the UE by the AAA server during the access authentication performed by the UE, so that the UE can obtain the trust type of the non-3GPP access system.

### FIELD OF THE INVENTION

The invention relates to the field of communication technology, in particular to a method, a system and a device for obtaining a trust type of a non-3GPP (3rd Generation Partnership Project) access system.

### BACKGROUND OF THE INVENTION

With the continuous development and popularization of non-3GPP access technologies, such as WLAN (Wireless Local Area Network), Wimax (Worldwide Interoperability For Microwave Access) etc., the future development trend of 3GPP focuses on how to effectively use the existing non-3GPP access technologies and non-3GPP access systems to provide users with access services. In the project of SAE (System Architecture Evolution) proposed by 3GPP, IP-based 3GPP services will be provided by different access technologies, thereby it is required to support seamless mobility among different access technologies, such as seamless mobility between 3GPP access system and non-3GPP access system (e.g. WLAN). For example, a driver can enjoy the access service provided by UTRAN (UMTS Territorial Radio Access Network) during the travel, and access the network via WLAN access system when he is in the building. In this way the cost is reduced, and the capability of 3GPP system is enhanced.

In SAE system, non-3GPP access system is divided into Trusted system and Untrusted system, an UE (User Equipment) uses different processing methods for different trust types of the non-3GPP access systems. When UE accessess to EPS (Evolved Packet System) via the Untrusted non-3GPP access system, UE can access the system via ePDG (evolved pocket gate) entity, and it is necessary to build IPSEC tunnel (IP security tunnel) between UE and ePDG. If UE accesses to EPS via the Trusted non-3GPP access system, the ePDG entity is not necessary, and it is not necessary to build the corresponding IPSEC tunnel.

The trust type information of the non-3GPP access system is very important and essential for UE which accessed to the EPS system. If the UE cannot obtain the trust type of the non-3GPP access system that from EPS system point of view, it will not know whether to select an ePDG or not, thus leading to the failure of connection.

Existing 3GPP protocol does not provide the method of obtaining the trust type of a non-3GPP access system. Subsequently, considering the handover between the 3GPP and the non 3gpp access system, the current 3GPP protocol will be briefly explained. It can be seen from this example that the current 3GPP protocol does not provide any method of obtaining a trust type of a non-3GPP access system.

FIG. 1 shows the system architecture for the handover between the non 3GPP access system and 3GPP access system, when UE hands over to the non-3GPP access system, UE can discover and select a suitable non-3GPP access system by a network discovering and selecting procedure. FIG. 2 shows the handover procedure with the following steps:

Step 201: UE has accessed to EPS system via a 3GPP access system or a non-3GPP access system.

Step 202: When it is necessary to perform a handover due to some conditions, a connection between UE and ANDSF (Access Network Discovery and Selection Function) is established. If UE does not have the address of the ANDSF entity, it shall initiate the ANDSF discovering procedure to discover an IP address of ANDSF entity. The ANDSF entity is an essential entity for the UE accessing the non 3gpp access system, it contains the data management and control function used for providing UE with discovering and selecting access system according to the operator's strategy. ANDSF may provide Inter-system mobility strategy and the non-3GPP access system information to UE, wherein information of the non-3GPP access system can be the non-3GPP access type (WLAN or Wimax), the non-3GPP access network identification (e.g. SSID of WLAN), PLMN for providing access and the preferable type of the non-3GPP etc.

Step 203: UE sends a request message to ANDSF for requesting the information of the non-3GPP access network.

Step 204: ANDSF selects the related the Inter-system mobility strategy and the information of the non-3GPP access system according to UE's position and sends information to the UE.

Step 205: UE makes a network selecting and handover decision.

Step 206: After UE has determined to handover to the non-3GPP access system, the handover procedure is initiated.

It can be seen from the above procedure that the ANDSF only sends the information of the non-3GPP access system and the Inter-system mobility strategy to UE, and it does not inform UE of the trust type of the non-3GPP access system, when UE hands over to the non-3GPP access system. The above procedure shows handover procedure from 3GPP access system or non-3GPP access system to a non-3GPP access system. Similarly, in the case that UE accesses EPS system via non 3gpp access system, UE cannot obtain the trust type of the non-3GPP access system either.

The disadvantage of the current technology is that UE can not obtain the trust type of the non-3GPP access system which is very important and essential for UE to access to the EPS system via the non-3GPP access system. In order to ensure UE accessing via non-3GPP system, an efficient, simple and quick way to obtaining the trust type of the non-3GPP access system is necessary.

### SUMMARY OF THE INVENTION

The object of the present invention is at least to obtain the trust type of the non 3gpp access system.

In order to achieve the above object, the present invention provides a method for obtaining the trust type of a non-3GPP access system, which includes the following steps: the UE establishing an underlying link to a non-3GPP access system selected by the UE; the UE initiating an access authentication request, and sending the identification information of the UE and the information of the non-3GPP access system to an AAA (Authentication, Authorization, Accounting) server through the non-3GPP access system; the UE receiving the access authentication response and the trust type of the non-3GPP access system, and the trust type of the non-3GPP access system. The trust type is determined by the AAA server based on the identification information of the UE, the information of the non-3GPP access system and the operator's strategy.

In one embodiment of the method, before the UE establishes an underlying link to a non-3GPP access system selected by the UE, it further comprises: UE discovering and selecting the non-3GPP access system and receiving the information of the non-3GPP access system from the ANDSF entity.

In one embodiment of the method, the step of the UE initiating an access authentication procedure and sending the identification information of the UE and the information of the non-3GPP access system to an AAA server through the non-3GPP access system with the following steps: the UE sending the non-3GPP access authentication request to the non-3GPP access system, during the procedure of the non-3GPP access authentication, sending the identification information of the UE and the information of the non-3GPP access system to the non-3GPP access system; and the non-3GPP access system translating the non-3GPP access authentication request to a network access authentication request and then sending the network access authentication request to an AAA server, and during the procedure of the network access authentication, sending the identification information of the UE and the information of the non-3GPP access system to the non-3GPP access system.

In one embodiment of the method, the UE receiving the access authentication response and the trust type of the non-3GPP access system returned from the AAA server includes: the UE receiving the returned access authentication response and the trust type of the non-3GPP access system is included in the returned access authentication response.

In the above embodiment, the access authentication response including the trust type of the non-3GPP access system includes: the AAA server sending the response to network access authentication request to the non-3GPP access system, and the network access authentication response including the trust type of the non-3GPP access system; the non-3GPP access system translating the network access authentication response to the non-3GPP access authentication response and then sending it to the UE, the non-3GPP access authentication response includes the trust type of the non-3GPP access system.

In one embodiment of the method, the step of the trust type of the non-3GPP access system being determined by the AAA server based on the identification information of the UE and the information of the non-3GPP access system further includes: the AAA server obtaining the subscription data of the UE based on the identification information of the UE; the AAA server determining the trust type of the non-3GPP access system based on the subscription data of the UE, the information of the non-3GPP access system and the operator's strategy.

In one embodiment of the method, after the UE receiving the returned access authentication response and the trust type of the non-3GPP access system, the method further includes: the UE deciding whether to use the ePDG entity based on the trust type of the non-3GPP access system or not to access the EPS system.

In order to achieve the above object, on the other hand, the present invention also provides a method for obtaining a trust type of a non-3GPP access system, which includes the following steps: a non-3GPP access system and a UE establishing a underlying link; the non-3GPP access system translating the non-3GPP access authentication request of the UE to the network access authentication request and sending the network access authentication request to an AAA server, and sending the identification information sent by the UE and the information of the non-3GPP access system to the AAA server; the non-3GPP access system translating the network access authentication response that including the trust type of the non-3GPP access system to a non-3GPP access authentication response and then sending the non-3GPP access authentication response to the UE, the UE obtaining the trust type of the non-3GPP access system based on the received non-3GPP access authentication response.

In one embodiment of the method, the trust type of the non-3GPP access system is determined by the AAA server based on the identification information of the UE and the information of the non-3GPP access system.

In one embodiment of the method, the step of the trust type of the non-3GPP access system being determined by the AAA server based on the identification information of the UE, the information of the non-3GPP access system and the operator's strategy further includes: the AAA server obtaining the subscription data of the UE based on the identification information of the UE; the AAA server determining the trust type of the non-3GPP access system based on the subscription data of the UE and the information of the non-3GPP access system.

In order to achieve the above object, the present invention further provides a method for obtaining a trust type of a non-3GPP access system with the following steps: an AAA server receiving a non-3GPP access authentication request initiated by a UE via a non-3GPP access system, and the identification information of the UE and the information of the non-3GPP access system which are sent by the non-3GPP access system; the AAA server determining the trust type of the non-3GPP access system based on the identification information of the UE, the information of the non-3GPP access system and the operator's strategy; the AAA server sending a the access authentication response including the trust type of the non-3GPP access system to the UE.

In one embodiment of the method, the step of the AAA server determining the trust type of the non-3GPP access system based on the identification information of the UE and the information of the non-3GPP access system further includes: the AAA server obtaining the subscription data of the UE based on the identification information of the UE; the AAA server determining the trust type of the non-3GPP access system based on the subscription data of the UE, the information of the non-3GPP access system and the operator's strategy.

The present invention also provides a method for determining a trust type of the non-3GPP access system with the following steps: an AAA server receiving the identification information of the UE and the information of the non-3GPP access system; the AAA server determining the trust type of the non-3GPP access system based on the identification information of the UE, the information of the non-3GPP access system and the operator's strategy.

In one embodiment of the method, the step of the AAA server determining the trust type of the non-3GPP access system based on the identification information of the UE and the information of the non-3GPP access system further includes: the AAA server obtaining the subscription data of the UE based on the identification information of the UE; the AAA server determining the trust type of the non-3GPP access system based on the subscription data of the UE, the information of the non-3GPP access system and the operator's strategy.

In order to achieve the above object, the present invention provides a system for obtaining the trust type of a non-3GPP access system, which includes: an AAA server, a non-3GPP access system and at least one UE; the UE being configured for initiating a access authentication request to the AAA server through the non-3GPP access system after the UE decides to establish a underlying link to the non-3GPP access system, and during the process of the access authentication request, sending the identification information of the UE and the information of the non-3GPP access system to the AAA server as well as receiving a returned access authentication response from the AAA server and the trust type of the non-3GPP access system; the non-3GPP access system, being configured for translating the access authentication request initiated by the UE and the returned access authentication response from the AAA server; the AAA server, being configured for determining the trust type of the non-3GPP access system based on the identification information of the UE, the information of the non-3GPP access system and the operator's strategy, and sending the determined trust type of the non-3GPP access system through the access authentication response to the UE.

In the embodiment of the above-mentioned system, the system further includes a home subscriber server (HSS) for providing the AAA server with the required subscription data of the UE.

The present invention further provides an user equipment (UE), including an underlying linking module, a access authentication request initiating module, an access authentication response receiving module and a trust type obtaining module, the underlying linking module being configured for establishing an underlying link to the non-3GPP access system selected by the UE; the access authentication request initiating module being configured for initiating an access authentication request to the AAA server through the non-3GPP access system and sending the identification information of the UE and the information of the non-3GPP access system to the AAA server through the non-3GPP access system; the access authentication response receiving module being configured for receiving the returned access authentication response from the AAA server; the trust type obtaining module being configured for parsing the access authentication response received by the access authentication response receiving module to obtain the trust type of the non-3GPP access system which is determined by the AAA server based on the identification information of the UE, the information of the non-3GPP access system and the operator's strategy.

In a specific embodiment, the UE further comprises a discovering and selecting module used for discovering and selecting the non-3GPP access system and receiving the information of the non-3GPP access system through the ANDSF entity.

In a specific embodiment, the UE further comprises a deciding module used for deciding whether to use the ePDG entity based on the trust type of the non-3GPP access system obtained by the trust type obtaining module or not to Access the EPS system.

The present invention further provides a non-3GPP access system which includes: a receiving module, a translating module, an adding module and a sending module, the receiving module, configured for receiving the non-3GPP access authentication request initiated by the UE and the returned network access authentication response from the AAA server; the translating module, configured for translating the non-3GPP access authentication request initiated by the UE to the network access authentication request, and translating the returned network access authentication response from the AAA server to the non-3GPP access authentication response; the adding module, configured for adding the identification information of the UE into the network access authentication request translated by the translating module, and adding the trust type of the non-3GPP access system into the non-3GPP access authentication response translated by the translating module; and the sending module, configured for sending the translated network access authentication request to the AAA server, and sending the translated non-3GPP access authentication response to the UE.

The present invention further provides an AAA server, including a receiving module, a trust type determining module, and an authentication response to sending module, the receiving module, configured for receiving the access authentication request initiated by the UE through the non-3GPP access system, and the identification information of the UE and the information of the non-3GPP access system sent through the non-3GPP access system; the trust type determining module, configured for determining the trust type of the non-3GPP access system based on the identification information of the UE and the information of the non-3GPP access system received by the receiving module and the operator's strategy; and the authentication response sending module, configured for sending the access authentication response that includes the trust type of the non-3GPP access system to the UE.

The present invention further provides an AAA server which includes a receiving module and a trust type determining module, the receiving module, configured for receiving the identification information of the UE and the information of the non-3GPP access system sent by the UE through the non-3GPP access system; the trust type determining module, configured for determining the trust type of the non-3GPP access system based on the identification information of the UE and the information of the non-3GPP access system received by the receiving module and the operator's strategy.

Correspondingly, the present invention also provides a network functional entity used for determining the trust type of the non-3GPP access system, which includes: a receiving module, and a trust type determining module, the receiving module, configured for receiving the identification information of the UE and the information of the non-3GPP access system sent by the UE through the non-3GPP access system; the trust type determining module, configured for determining the trust type of the non-3GPP access system based on the identification information of the UE and the information of the non-3GPP access system received by the receiving module and the operator's strategy.

In the present invention, during the access authentication initiated by the UE, the AAA server determines the trust type of the non-3GPP access system based on the identification information of the UE and the information of the non-3GPP access system, and informs the UE through the non-3GPP access system, so that the UE can obtain the trust type of the non-3GPP access system, and thereby enables the UE to decide whether to use the ePDG entity based on the trust type of the non-3GPP access system or to access the EPS system.

Other aspects and advantages of the present invention will be illustrated in the following description and parts of them will become apparent through the following description or be understood through the embodiments of the present invention.

### BRIEF DESCRIPTION OF THE DRAWINGS

The above and/or other aspects and advantages of the present invention will become apparent and easily understandable through the following description of the embodiments in conjunction with accompanying drawings, wherein:

FIG. 1 is a schematic view showing system architecture of handover UE to a non-3GPP access system in 3GPP protocol;

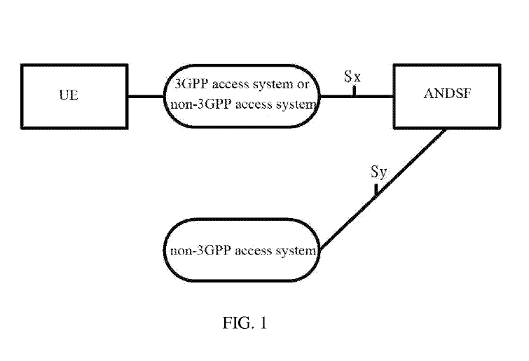

FIG. 2 is a flowchart showing a UE is handed over to a non-3GPP access system in 3GPP protocol,

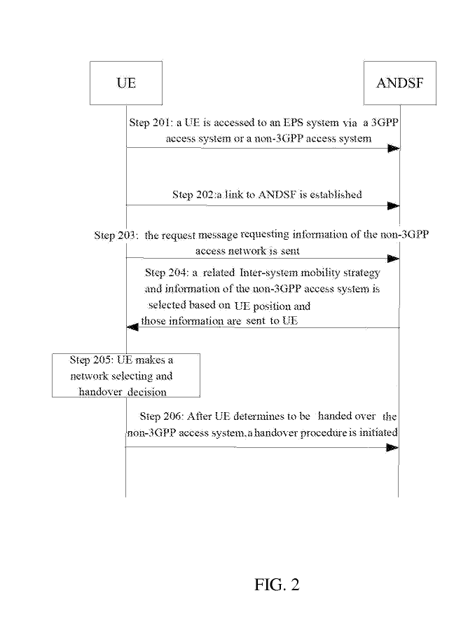

FIG. 3 is a flowchart showing a method for obtaining a trust type of a non-3GPP access system according to Embodiment 1 of the present invention,

FIG. 4 is a flowchart showing a method for obtaining a trust type of a non-3GPP access system according to Embodiment 2 of the present invention,

FIG. 5 is a structural view showing a system for obtaining a trust type of a non-3GPP access system of the present invention,

FIG. 6 is a structural view of an AAA server of the present invention,

FIG. 7 is a structural view of a network functional entity of the present invention.

### DETAILED DESCRIPTION OF THE PRESENT INVENTION

Hereafter, the embodiments of the present invention will be illustrated in detail, and the examples of the embodiments are shown in figures, wherein identical or similar reference numbers designate identical or similar elements or composite parts having identical or similar functions throughout. The following embodiments described with reference to figures are merely examples and are only used to illustrate the present invention rather than being construed as limiting the present invention.

The present invention aims to: when the UE is required to access the EPS system through the non-3GPP access system, the trust type of the non-3GPP access system is determined by devices of a network side during the access authentication procedure, and the determined type is informed to the UE. In this way, not only can the UE obtains the trust type of the non-3GPP access system, but also the trust type of the non-3GPP access system can be determined by devices of the network side according to the operator's strategy. In one embodiment of the present invention, the access type of the non-3GPP access system may be determined and informed to the UE by the AAA server. Preferably, the UE can send a access authentication request including the identification information of the UE and the information of the non-3GPP access system to the AAA server, and the UE is informed of the trust type of the non-3GPP access system determined by the AAA server and the trust type is included in the access authentication response. It should be noted that it is a preferable manner of the present invention to determine the access type of the non-3GPP access system by the AAA server, and the determination may also be performed by other network functional entity. Similarly, it is a preferable manner as well to send the identification information of the UE and the information of the non-3GPP access system by including above information in the access authentication request sent to the AAA server, and this can also be realized by including the identification information of the UE and the information of the non-3GPP access system in an newly defined message and send the newly defined message to the AAA server. Thus, variations similar to the above and understandable for a person skilled in the art should fall within the scope of protection of the embodiments of the present invention.

Hereafter, the preferable solutions of the present invention will be described in detail, however, it does not mean that the present invention can only be realized by the following solutions.

### Embodiment 1

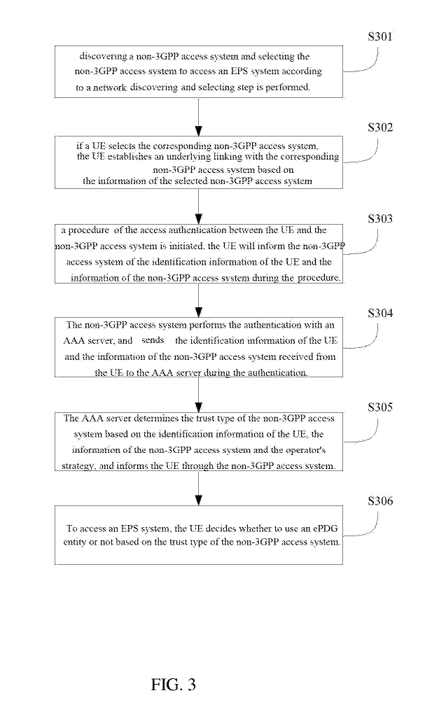

FIG. 3 is a flowchart showing a method for obtaining a trust type of a non-3GPP access system according to Embodiment 1 of the present invention, wherein the method comprises the following steps:

Step 301: an UE discovers a non-3GPP access system and selects it to access an EPS system through the selected non-3GPP access system according to a network discovering and selecting step. For example, when the UE is handed over from a 3GPP access system to the non-3GPP access system, or directly accesses the EPS system from the non-3GPP access system, it will perform the network discovering and selecting procedure. During this procedure, ANDSF may provide the UE with some information of the access system, such as Inter-System mobility strategy and information of the non-3GPP access system (such as PLMN-ID).

Step 302: If the UE selects the corresponding non-3GPP access system, the UE would establish an underlying linking with the corresponding non-3GPP access system according to the selected information of the non-3GPP access system.

Step 303: An access authentication is initiated between the UE and the non-3GPP access system, after the establishment of the underlying link between the UE and the non-3GPP access system. During the access authentication procedure, the UE will inform the non-3GPP access system of PLMN-ID, the identification information of the UE (such as network address identifier MN-NAI) and the access type information and etc. The above access authentication can be performed by EAP (Extensible Authentication Protocol). Please be noted that the access authentication procedure can vary according to different types of the non-3GPP access system. For example, for WLAN, a corresponding EAP authentication is selected, and for Wimax, another EAP authentication will be selected. Furthermore, corresponding to different types of the authentication, there are different numbers of EPA requests and responses. In addition, different types of the access system may also lead to different encapsulation of EAP data packet. Thus, the present invention does not limit to the authentication method adopted in authentication initiated by the UE. In one embodiment of the present invention, during the process when UE initiates the authentication procedure, the identification information of the UE and the information of the non-3GPP access system are sent to the non-3GPP access system.

Step 304: The authentication is performed between the non-3GPP access system and an AAA server, and the non-3GPP access system sends the identification information of the UE and the information of the non-3GPP access system received from the UE to the AAA server during the authentication procedure. In case of roaming, the non-3GPP access system needs to interact with the AAA server through an AAA proxy server.

Step 305: The AAA server determines the trust type of the non-3GPP access system based on the identification information of the UE, the information of the non-3GPP access system and the operator's strategy, and informs the UE of the trust type through the non-3GPP access system. The AAA server can inform the UE of the trust type of the non-3GPP access system according to the subscription data of the user and the rules, such as whether there is a roaming agreement between operators. If the AAA server has no subscription information of the UE, then the AAA server may interact with HHS (Home Subscriber Server) to obtain the subscription data of the UE. Among which, the operator's strategy is configured by the operator of the EPS system, which may be configured into the AAA server, and the configured operator's strategy may be modified flexibly. For example, the AAA server may obtain the operator's information of the non-3GPP access system accessed to the UE according to PLMN ID, and determine the trust type of the non-3GPP access system according to whether there is a valid roaming agreement. If the operator deems that there is a valid roaming agreement with the operator of the non-3GPP access system, then the non-3GPP access system can be regarded safe and reliable, thus the AAA server can set the trust type of the non-3GPP access network as Trusted. Otherwise, if the operator deems that the operator of the non-3GPP access network is not reliable or the non-3GPP access system is not safe and reliable based on the information of PLMN ID, RAT type etc., the AAA server sets the trust type of the non-3GPP access system as Untrusted. In one embodiment of the present invention, the AAA server can transmit the trust type of the non-3GPP access system to the UE through the access authentication response, and may select to expand the message of the access authentication response so as to include the trust type. Certainly, the AAA server may also inform the UE through an individual message, either newly defined message or existing message. Similarly, in this step, the AAA server can also send the trust type of the non-3GPP access system to the UE after the access authentication of the UE is successful. If the UE fails to pass the access authentication, then the AAA server is not required to send the trust type of the non-3GPP access system to the UE.

Step 306: To access an EPS system, the UE decides whether to use an ePDG entity or not based on the trust type of the non-3GPP access system. If the type of the non-3GPP access system is trusted, then the UE may continue operating in accordance with Trusted non-3GPP access process or handover process, if the type of the non-3GPP access system is untrusted, then the UE may resort to an ePDG to continue operating in accordance with Untrusted non-3GPP access process or handover process, and then it is necessary to establish an IPSEC tunnel between the UE and the ePDG.

### Embodiment 2

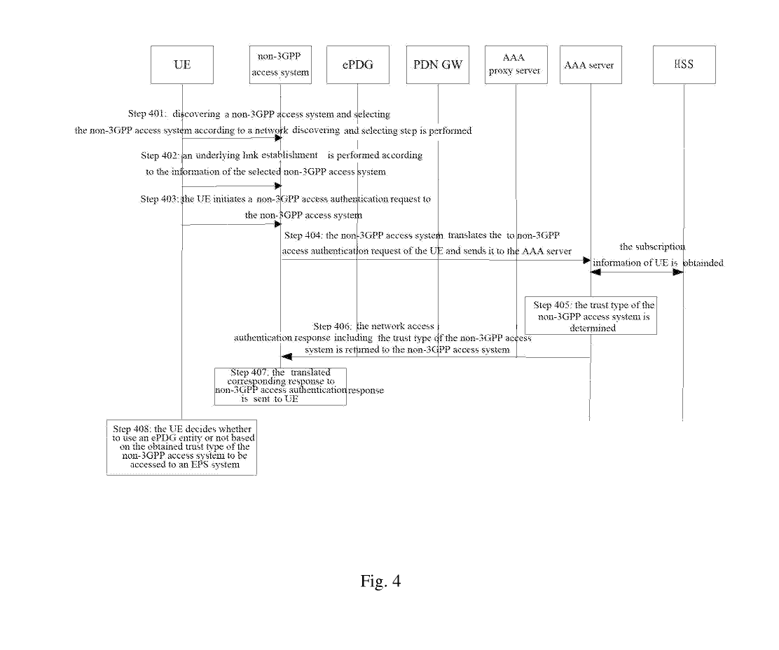

FIG. 4 is a flowchart showing a method for obtaining a trust type of a non-3GPP access system according to Embodiment 2 of the present invention. In order to explain the flow of the present invention in detail, the access authentication between the UE and the non-3GPP access system is referred to as a non-3GPP access authentication which will change depending upon different non-3GPP access systems. If the non-3GPP access system is WLAN, then the access authentication of WLAN will be adopted. If the non-3GPP access system is Wimax, then the access authentication of Wimax will be adopted. Furthermore, the access authentication between the non-3GPP access system and the AAA server is referred to be a network access authentication which includes but not limited to RADIUS (Remote Authentication Dial-In User Service) authentication and Diameter protocol, as well as other network authentication protocols which will appear and be developed in the future. The method comprises the following steps:

Step 401: an UE discovers a non-3GPP access system and selects to access an EPS system through the non-3GPP access system according to a network discovering and selecting process. For example, when the UE is handed over from a 3GPP access system to the non-3GPP access system, or directly accesses the EPS system through the non-3GPP access system, the network discovering and selecting process will be performed. During this process, ANDSF may inform the UE of information of the access system, for example Inter-System mobility strategy and information of the non-3GPP access system (such as PLMN-ID).

Step 402: If the UE selects the corresponding non-3GPP access system, the UE would establish an underlying link with the non-3GPP access system according to the information of the selected non-3GPP access system.

Step 403: The UE initiates a non-3GPP access authentication request to the non-3GPP access system, which can be achieved by performing the extensible authentication protocol EAP. During the process of the non-3GPP access authentication request, the identification information of the UE (such as MN-NAI) and the information of the non-3GPP access system (PLMN-ID, and the access type of the non-3GPP access system etc.) are sent to the non-3GPP access system. Preferably, the UE sends the identification information of the UE and the information of the non-3GPP access system to the non-3GPP access system through the non-3GPP access authentication message.

Step 404: The non-3GPP access system translates the non-3GPP access authentication request sent by the UE and sends it to the AAA server. In particular, the non-3GPP access authentication request is translated to the corresponding network access authentication request such as an RADIUS access authentication request. The identification information of the UE and the information of the non-3GPP access system are sent to the AAA server simultaneously. Preferably, the RADIUS access authentication request may include the identification information of the UE and the information of the non-3GPP access system.

Step 405: The AAA server determines the trust type of the non-3GPP access system based on the identification information of the UE, the information of the non-3GPP access system and the operator's strategy. Among which, the operator's strategy is configured by the operator of the EPS system, which may be configured into the AAA server, and the configured operator's strategy may be modified flexibly. In one embodiment of the present invention, the AAA server can inform the UE of the trust type of the non-3GPP access system according to the subscription data of the user and the rules, such as whether there is a roaming agreement with other operators. If the AAA server has no subscription information of the UE, then the AAA server may interact with HHS to obtain the subscription data of the UE from HHS. For example, the AAA server may obtain the information of the operator to which the UE is accessed according to PLMN ID, and determine the trust type of the non-3GPP access system according to whether there is a valid roaming agreement. If the operator deems that there is a valid roaming agreement with the operator of the non-3GPP access system, then the non-3GPP access system can be regarded safe and reliable, thus the AAA server can set the trust type of the non-3GPP access network as Trusted. Otherwise, if the operator deems that the operator of the non-3GPP access network is not reliable or the non-3GPP access system is not safe and reliable based on the information such as PLMN ID, RAT type, then the AAA server sets the trust type of the non-3GPP access system as Untrusted.

Step 406: The AAA server returns a response network access authentication to the non-3GPP access system, wherein the response includes the trust type of the non-3GPP access system. In one embodiment of the present invention, the AAA server will return a successful authentication response to the non-3GPP access system only when the UE is authenticated to access to the non-3GPP access system, wherein the response includes the trust type of the non-3GPP access system. If the AAA server does not agree to grant the access right to UE to the non-3GPP access system, then successful authentication response will be not be returned.

Step 407: The non-3GPP access system translates the network access authentication response to the corresponding non-3GPP access authentication response and send the non-3GPP access authentication response to the UE. For example, a RADIUS access authentication response is translated to the corresponding the WLAN access authentication response. Furthermore, the translated response to non-3GPP access authentication also includes the trust type of the non-3GPP access system determined by the AAA server.

Step 408: UE obtains the trust type of the non-3GPP access system based on the received non-3GPP access authentication response, and decides whether to use an ePDG entity or not based on the obtained trust type of the non-3GPP access system to be accessed to an EPS system. If the type of the non-3GPP access system is trusted, then the UE may continue operating in accordance with Trusted non-3GPP access process or handover process, if the type of the non-3GPP access system is untrusted, then the UE may resort to an ePDG to continue operating in accordance with Untrusted non-3GPP access process or handover process, and it is necessary to establish an IPSEC tunnel between the UE and the ePDG.

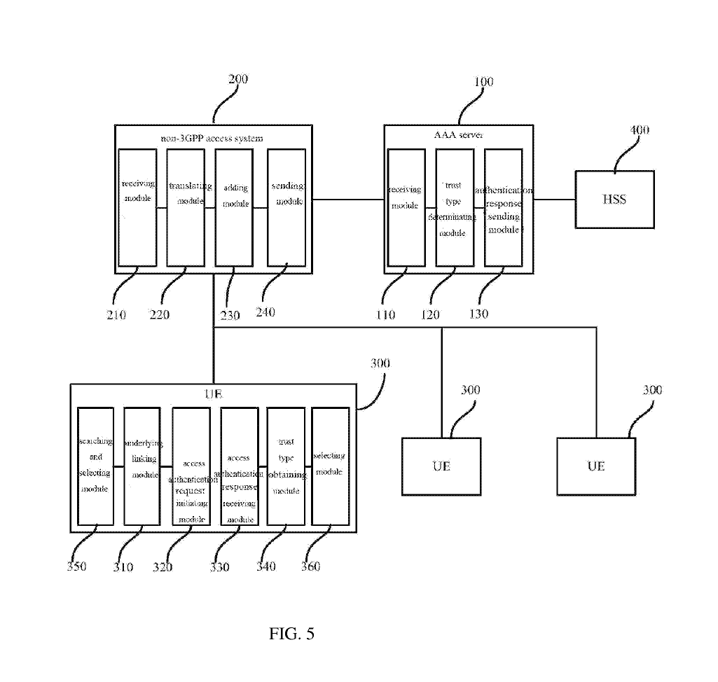

FIG. 5 is a structural view showing a system for obtaining a trust type of a non-3GPP access system of the present invention, wherein the system includes: an AAA server 100, a non-3GPP access system 200 and at least one UE 300. The UE 300 initiates a access authentication request to the AAA server 100 through the non-3GPP access system 200 after the UE 300 selects to establish a underlying link with the non-3GPP access system 200, sends the identification information of the UE 300 and the information of the non-3GPP access system to the AAA server 100 during the process of the access authentication request, and receives a returned response access authentication from the AAA server 100 and the trust type of the non-3GPP access system 200 which is determined by the AAA server 100 based on the identification information of the UE 300, the information of the non-3GPP access system and the operator's strategy. The non-3GPP access system 200 is used for translating the access authentication request initiated by the UE 300 and the returned access authentication response to from the AAA server 100. For example, the corresponding access authentication request of WLAN is translated to a RADIUS authentication request, and a RADIUS authentication response is translated to the corresponding access authentication response of WLAN. The AAA server 100 is used to determine the trust type of the non-3GPP access system 200 based on the identification information of the UE 300, the information of the non-3GPP access system 200 and the operator's strategy, and to send the determined trust type of the non-3GPP access system 200 through the access authentication response to the UE 300. In one embodiment of the present invention, The AAA server 100 can inform the UE 300 of the trust type of the non-3GPP access system 200 according to the subscription data of the user and the rules, such as whether there is a roaming agreement with other operators. If the AAA server 100 has no subscription information of the UE 300, then the AAA server 100 may interact with HHS 400 to obtain the subscription data of the UE 300 from the HHS 400. Thus, the system also includes the HHS 400 configured for providing the AAA server 100 with required subscription data of the UE 300. For example, the AAA server 100 may obtain the operator's information of the non-3GPP access system 200 accessed to the UE 300 according to PLMN ID, and determine the trust type of the non-3GPP access system 200 according to whether there is a valid roaming agreement. If the operator deems that there is a valid roaming agreement with the operator of the non-3GPP access system 200, then the non-3GPP access system 200 can be regarded safe and reliable, thus the AAA server 100 can set the trust type of the non-3GPP access network 200 as Trusted. Otherwise, if the operator deems that the operator of the non-3GPP access system 200 is not reliable or the non-3GPP access system 200 is not safe and reliable based on the information such as PLMN ID, RAT type, then the AAA server 100 sets the trust type of the non-3GPP access system 200 as Untrusted.

The user equipment (UE) 300 includes a underlying linking module 310, an access authentication request initiating module 320, an access authentication response receiving module 330 and a trust type obtaining module 340, wherein the underlying linking module 310 is configured for establishing a underlying link with the non-3GPP access system 200 selected by the UE 300; the access authentication request initiating module 320 is configured for initiating a access authentication request to the AAA server 100 through the non-3GPP access system 200 and sending the identification information of the UE 300 and the information of the non-3GPP access system 200 to the AAA server 100 through the non-3GPP access system 200, wherein the information of the non-3GPP access system 200 can be obtained from ANDSF; the access authentication response receiving module 330 is configured for receiving the response to access authentication returned from the AAA server 100; the trust type obtaining module 340 is configured for parsing the response to access authentication received by the access authentication response receiving module 330 to obtain the trust type of the non-3GPP access system 200 which is determined by the AAA server 100 based on the identification information of the UE 300 (such as MN-NAI), the information of the non-3GPP access system 200 (PLMN-ID, and the access type of the non-3GPP access system etc.) and the operator's strategy.

In one embodiment of the present invention, the above UE 300 further comprises a discovering and selecting module 350 for discovering and selecting the non-3GPP access system 200 and receiving the information of the non-3GPP access system 200 through the ANDSF entity.

In another embodiment of the present invention, the above UE 300 further comprises a deciding module 360 for deciding whether UE use the ePDG entity or not based on the trust type of the non-3GPP access system 200 obtained by the trust type obtaining module 340 to access the EPS system.

The non-3GPP access system 200 includes: a receiving module 210, a translating module 200, an adding module 230 and a sending module 240. The receiving module 210 is used to receive the non-3GPP access authentication request initiated by the UE 300 and the returned network access authentication response from the AAA server 100. The translating module 220 is used to translate the non-3GPP access authentication request initiated by the UE 300 to the network access authentication request, and translate the returned network access authentication response from the AAA server 100 to the non-3GPP access authentication response. For example, the corresponding access authentication request of WLAN is translated to the RADIUS authentication request, and the RADIUS authentication response is translated to the corresponding access authentication response of WLAN. The adding module 230 is used to add the identification information of the UE 300 into the network access authentication request translated by the translating module 220, and add the trust type of the non-3GPP access system 200 into the non-3GPP access authentication response translated by the translating module 220. The sending module 240 is used to send the translated network access authentication request to the AAA server 100, and transmit the translated non-3GPP access authentication response to the UE 300.

The AAA server 100 includes a receiving module 110, a trust type determining module 120, and an authentication response sending module 130. The receiving module 110 is used to receive an access authentication request initiated by the UE 300 through the non-3GPP access system 200, and the identification information of the UE 300 and the information of the non-3GPP access system sent by the non-3GPP access system 200. The trust type determining module 130 is used to determine the trust type of the non-3GPP access system based on the identification information of the UE 300 and the information of the non-3GPP access system received by the receiving module 110 as well as the operator's strategy. The authentication response sending module 130 is used to send the trust type of the non-3GPP access system 200 included in the access authentication response to the UE 300.

Through the above system, during procedure of the access authentication initiated by the UE, the AAA server can determine the trust type of the non-3GPP access system based on the identification information of the UE and the information of the non-3GPP access system, and the operator's strategy, informs the UE through the non-3GPP access system to enable the UE to obtain the trust type of the non-3GPP access system. Therefore, the UE is capable of deciding whether to use the ePDG entity or not based on the trust type of the non-3GPP access system to access the EPS system.

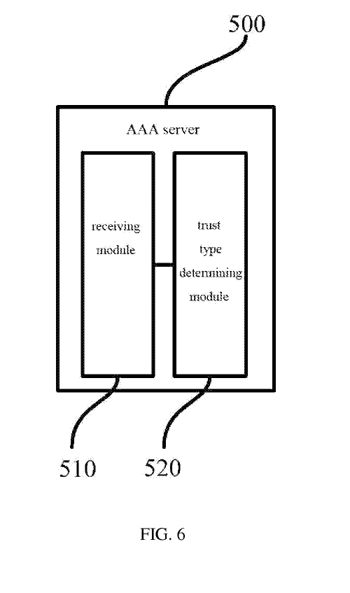

In the embodiment of the present invention, it further provides an AAA server for determining the trust type of the non-3GPP access system. FIG. 6 is a structural view of the AAA server of the present invention. The AAA server 500 can determine the trust type of the non-3GPP access system 200 based on the identification information of the UE 300 and the information of the non-3GPP access system 200, and this AAA server 500 includes a receiving module 510, and a trust type determining module 520. The receiving module 510 is used to receive the identification information of the UE 300 (MN-NAI etc.) and the information of the non-3GPP access system 200 (PLMN-ID, the access type of the non-3GPP access system etc.) sent by the UE 300 through the non-3GPP access system 200. The trust type determining module 520 is used to determine the trust type of the non-3GPP access system 200 based on the identification information of the UE 300 and the information of the non-3GPP access system 200 received by the receiving module 510, and the operator's strategy allocated on the AAA server 500.

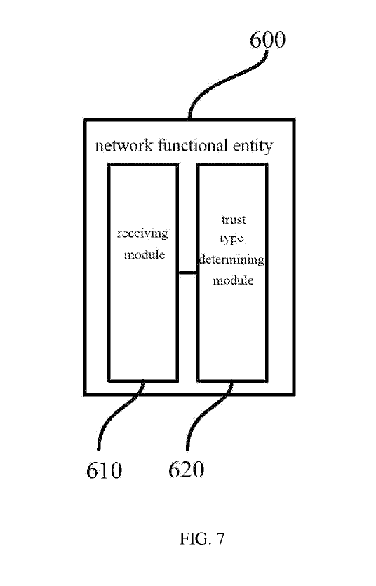

However, the above-mentioned way to determine the access type of the non-3GPP access system by the AAA server is only one way to realize the function by the present invention, and it can also be realized by other network functional entities. Thus, the present invention provides a further network functional entity for determining the trust type of the non-3GPP access system. FIG. 7 is a structural view of a network functional entity 600 of the present invention which includes: a receiving module 610, and a trust type determining module 620. The receiving module 610 is used to receive the identification information of the UE 300 and the information of the non-3GPP access system 200 sent by the UE 300 through the non-3GPP access system 200. The trust type determining module 620 is used to determine the trust type of the non-3GPP access system 200 based on the identification information of the UE 300 and the information of the non-3GPP access system 200 received by the receiving module 610, and the allocated operator's strategy.

In the present invention, during procedure of the access authentication initiated by the UE, the AAA server can determine the trust type of the non-3GPP access system based on the identification information of the UE and the information of the non-3GPP access system, and the operator's strategy, and informs the UE through the non-3GPP access system to enable the UE to obtain the trust type of the non-3GPP access system. Therefore, the UE is capable of deciding whether to use the ePDG entity or not based on the trust type of the non-3GPP access system to access the EPS system.

The embodiments of the present invention have been shown and described in the above, and a person skilled in the art could subject these embodiments to various variations, modifications, substitutions and transformations without departing from the principle and spirit of the present invention, and the scope of protection of the present invention is defined by the appended claims and equivalents thereof.

1. A method for obtaining a trust type of a non-3GPP access system, wherein comprising:
a user equipment UE establishing a underlying link with a non-3GPP access system selected by the UE;
the UE initiating an access authentication request and sending the identification information of the UE and the information of the non-3GPP access system to an Authentication, Authorization, Accounting server through the non-3GPP access system;
the UE receiving a returned access authentication response and the trust type of the non-3GPP access system, and the trust type of the non-3GPP access system being determined by the AAA server based on the identification information of the UE, the information of the non-3GPP access system and the operator's strategy.

2. The method for obtaining a trust type of a non-3GPP access system of claim 1, wherein before the UE establishes the underlying link with the non-3GPP access system selected by the UE, it further comprises:
the UE discovering and selecting the non-3GPP access system and receiving the information of the non-3GPP access system from an Access Network Discovery and Selection Function (ANDSF) entity.

3. The method for obtaining a trust type of a non-3GPP access system of claim 1, wherein, the step of the UE initiating an access authentication request and sending the identification information of the UE and the information of the non-3GPP access system to an AAA server through the non-3GPP access system, it further comprises the following steps:
the UE initiating a non-3GPP access authentication request to the non-3GPP access system, and during the process of the non-3GPP access authentication request t, sending the identification information of the UE and the information of the non-3GPP access system to the non-3GPP access system;
the non-3GPP access system translating the non-3GPP access authentication request to a network access authentication request and then sending it to the AAA server, and during the process of the network access authentication request, sending the identification information of the UE and the information of the non-3GPP access system to the non-3GPP access system.

4. The method for obtaining a trust type of a non-3GPP access system of claim 1, wherein, the step of the UE receiving a returned access authentication response and the trust type of the non-3GPP access system comprises:
the UE receiving a returned access authentication response including the trust type of the non-3GPP access system.

5. The method for obtaining a trust type of a non-3GPP access system of claim 4, wherein, the access authentication response including the trust type of the non-3GPP access system is an non-3GPP access authentication response, and the non-3GPP access authentication response is sent to the UE through the following steps:
the AAA server sending the network access authentication response to the non-3GPP access system, and the network access authentication response including the trust type of the non-3GPP access system;
the non-3GPP access system translating the network access authentication response to the non-3GPP access authentication response and then sending it to the UE, the non-3GPP access authentication response to including the trust type of the non-3GPP access system.

6. The method for obtaining a trust type of a non-3GPP access system of claim 1, wherein, the step of the trust type of the non-3GPP access system being determined by the AAA server based on the identification information of the UE, the information of the non-3GPP access system and the operator's strategy comprises:
the AAA server obtaining the subscription data of the UE based on the identification information of the UE;
the AAA server determining the trust type of the non-3GPP access system based on the subscription data of the UE, the information of the non-3GPP access system and the operator's strategy,
wherein, after the UE receives the returned access authentication response and the trust type of the non-3GPP access system, the method further includes:
the UE deciding whether to use an evolved packet data guide (ePDG) entity or not based on the trust type of the non-3GPP access system to access an evolved packet system (EPS) system.

7. (canceled)

8. A method for obtaining a trust type of a non-3GPP access system, wherein, the method includes:
a non-3GPP access system establishing a underlying link with an UE;
the non-3GPP access system translating an non-3GPP access authentication request to of the UE to a network access authentication request and sending it to an AAA server, and sending the identification information sent by the UE and the information of the non-3GPP access system to the AAA server;
the non-3GPP access system translating the network access authentication response including the trust type of the non-3GPP access system to an non-3GPP access authentication response and then sending it to the UE, the UE obtaining the trust type of the non-3GPP access system based on the non-3GPP access authentication response.

9. The method for obtaining a trust type of a non-3GPP access system of claim 8, wherein, the trust type of the non-3GPP access system is determined by the AAA server based on the identification information of the UE, the information of the non-3GPP access system and the operator's strategy, and
wherein, the step of the trust type of the non-3GPP access system being determined by the AAA server based on the identification information of the UE, the information of the non-3GPP access system and the operator's strategy comprises:
the AAA server obtaining the subscription data of the UE based on the identification information of the UE;
the AAA server determining the trust type of the non-3GPP access system based on the subscription data of the UE, the information of the non-3GPP access system and the operator's strategy.

10. (canceled)

11. A method for obtaining a trust type of a non-3GPP access system, wherein, the method comprises:
an AAA server receiving an non-3GPP access authentication request initiated by a UE via a non-3GPP access system, and receiving the identification information of the UE and the information of the non-3GPP access system sent by the UE through the non-3GPP access system;
the AAA server determining the trust type of the non-3GPP access system based on the identification information of the UE, the information of the non-3GPP access system and the operator's strategy;
the AAA server sending an access authentication response including the trust type of the non-3GPP access system to the UE.

12. The method for obtaining a trust type of a non-3GPP access system of claim 11, wherein, the step of the AAA server determining the trust type of the non-3GPP access system based on the identification information of the UE and the information of the non-3GPP access system and the operator's strategy comprises:
the AAA server obtaining the subscription data of the UE based on the identification information of the UE;
the AAA server determining the trust type of the non-3GPP access system based on the subscription data of the UE, the information of the non-3GPP access system and the operator's strategy.

13. A method for determining a trust type of a non-3GPP access system, wherein, the method comprises the following steps:
an AAA server receiving the identification information of the UE and the information of the non-3GPP access system;
the AAA server determining the trust type of the non-3GPP access system based on the identification information of the UE, the information of the non-3GPP access system and the operator's strategy.

14. The method for obtaining a trust type of a non-3GPP access system of claim 13, wherein, the step of the AAA server determining the trust type of the non-3GPP access system based on the identification information of the UE, the information of the non-3GPP access system and the operator's strategy comprises:
the AAA server obtaining the subscription data of the UE based on the identification information of the UE;
the AAA server determining the trust type of the non-3GPP access system based on the subscription data of the UE, the information of the non-3GPP access system and the operator's strategy.

15. A system for obtaining a trust type of a non-3GPP access system, wherein, the system comprises: an AAA server, a non-3GPP access system and at least one UE;
the UE, configured for initiating an access authentication request to the AAA server through the non-3GPP access system after the UE decides to establish a underlying link with the non-3GPP access system, and during the process of the access authentication request, sending the identification information of the UE and the information of the non-3GPP access system to the AAA server, as well as receiving a returned access authentication response from the AAA server and the trust type of the non-3GPP access system;
the non-3GPP access system, configured for translating the access authentication request initiated by the UE and the returned access authentication response from the AAA server;
the AAA server, configured for determining the trust type of the non-3GPP access system based on the identification information of the UE, the information of the non-3GPP access system and the operator's strategy, and sending the determined trust type of the non-3GPP access system through the response to access authentication to the UE.

16. The system for obtaining a trust type of a non-3GPP access system of claim 15, wherein, the system further comprises a home subscriber server HSS configured for providing the AAA server with the subscription data of the UE.

17. A user equipment UE, wherein, the UE comprises a underlying linking module, an access authentication request initiating module, an access authentication response receiving module and a trust type obtaining module
the underlying linking module, configured for establishing a underlying link to the non-3GPP access system selected by the UE;
the access authentication request initiating module, configured for initiating an access authentication request to the AAA server through the non-3GPP access system and sending the identification information of the UE and the information of the non-3GPP access system to the AAA server through the non-3GPP access system;
the access authentication response receiving module, configured for receiving the returned access authentication response from the AAA server;
the trust type obtaining module, configured for parsing the response to access authentication received by the response to access authentication receiving module; obtaining the trust type of the non-3GPP access system which is determined by the AAA server based on the identification information of the UE, the information of the non-3GPP access system and the operator's strategy.

18. The user equipment UE of claim 17, wherein, the UE further comprises a discovering and selecting module configured for discovering and selecting the non-3GPP access system and receiving the information of the non-3GPP access system through the ANDSF entity, or
wherein, the UE further comprises a deciding module configured for deciding whether use the ePDG entity or not based on the trust type of the non-3GPP access system obtained by the trust type obtaining module to access the EPS system.

19. (canceled)

20. A non-3GPP access system, wherein, it comprises: a receiving module, a translating module, an adding module and a sending module,
the receiving module, configured for receiving the non-3GPP access authentication request initiated by the UE and the returned response to network access authentication from the AAA server;
the translating module, configured for translating the non-3GPP access authentication request initiated by the UE to the network access authentication request, and translating the returned network access authentication response from the AAA server to the non-3GPP access authentication response;
the adding module, configured for adding the identification information of the UE into the network access authentication request translated by the translating module, and adding the trust type of the non-3GPP access system into the non-3GPP access authentication response translated by the translating module; and
the sending module, configured for sending the translated network access authentication request to the AAA server, and sending the translated non-3GPP access authentication response to the UE.

21. An AAA server, wherein, it comprises a receiving module, a trust type determining module, and an authentication response sending module,
the receiving module, configured for receiving the access authentication request initiated by the UE through the non-3GPP access system, and the identification information of the UE and the information of the non-3GPP access system sent by the non-3GPP access system;
the trust type determining module, configured for determining the trust type of the non-3GPP access system based on the identification information of the UE and the information of the non-3GPP access system received by the receiving module and the operator's strategy; and
the authentication response sending module, configured for sending the access authentication response including the trust type of the non-3GPP access system to the UE.

22. An AAA server, wherein, it comprises a receiving module, and a trust type determining module,
the receiving module, configured for receiving the identification information of the UE and the information of the non-3GPP access system sent by the UE through the non-3GPP access system;
the trust type determining module, configured for determining the trust type of the non-3GPP access system based on the operator's strategy and the identification information of the UE and the information of the non-3GPP access system received by the receiving module.

23. A network functional entity for determining a trust type of a non-3GPP access system, wherein, it comprises: a receiving module, and a trust type determining module,
the receiving module, configured for receiving the identification information of the UE and the information of the non-3GPP access system sent by the UE through the non-3GPP access system;
the trust type determining module, configured for determining the trust type of the non-3GPP access system based on the operator's strategy and the identification information of the UE and the information of the non-3GPP access system received by the receiving module.
